(19) United States
(12) Patent Application Publication
(10) Pub. No.: US 2019/0087645 A1
(43) Pub. Date: Mar. 21, 2019

(54) Real Time Selfie Pose Verification

(71) Applicant: PAG Financial International LLC, Guaynabo, PR (US)

(72) Inventors: PAVAN AGARWAL, Cerritos, CA (US); JONATHAN ORTIZ RIVERA, Cerritos, CA (US); GABRIEL ALBORS SANCHEZ, Cerritos, CA (US)

(73) Assignee: PAG Financial International LLC, Guaynabo, PR (US)

(21) Appl. No.: 15/706,590

(22) Filed: Sep. 15, 2017

(51) Int. Cl. G06K 9/00; G06Q 10/06; G06Q 50/00

(52) U.S. Cl. CPC G06K 9/00288; G06Q 50/01; G06Q 10/06393; G06K 9/00369

(57) ABSTRACT

According to various embodiments of the disclosed technology, a system and method for validating the identity of an online account user in real time is disclosed. The system may include a processor; a memory attached to the processor; a computer readable medium having instruction embedded therein, the instructions configured to cause the processor to perform the operations of: creating a user profile for an online account for a first user, where the user profile may include a picture of a first user's face; receiving a request from a second user requesting to verify the picture of the first user as being an authentic representation of the first user's face; presenting through a computing device instructions of a specified pose for the first user to pose in a verification photo; and submitting the verification photo of the first user with the specified pose to the second user for verification.

### TECHNICAL FIELD

The disclosed technology relates generally to biometric identification for online security purposes. More specifically, the disclosed technology relates to biometric identification for online security purposes using real time picture verification to confirm the identity of the user.

### BACKGROUND

With the accessibility and mainstream nature of social media, the social media platform has become a convenient and accessible way for people to meet new people and expand their network of friends and personal relationships. While social media allows people to become introduced a wider network of people, the obvious downside is that all first interactions with such people on social media must be initiated online behind electronic screens rather than face-to-face interactions. As such, users must trust and assume that the person represented in his or her profile picture on the social media account is an accurate physical representation of that person in real life.

However, often, the profile picture of a person's social media account is often modified, outdated, or completely false. This phenomenon of deceiving people with faulty profile pictures has led to the coining of the term “catfish,” which is now a common term used to describe such online scenarios where someone fabricates an online identity to deceive others on social media. As a result, there is a need for authenticating social media users or other online users in real time for security and verification purposes.

### BRIEF SUMMARY OF EMBODIMENTS

According to various embodiments of the disclosed technology, a system for validating the identity of an online account user in real time is disclosed. The system may include a processor; a memory attached to the processor; a computer readable medium having instruction embedded therein, the instructions configured to cause the processor to perform the operations of: creating a user profile for an online account for a first user, where the user profile includes a picture of a first user's face; receiving a request from a second user requesting to verify the picture of the first user as being an authentic representation of the first user's face; presenting through a computing device instructions of a specified pose for the first user to pose in a verification photo; and submitting the verification photo of the first user with the specified pose to the second user for verification.

Also disclosed are methods for validating the identity of an online account user in real time. The method may include at least creating a user profile for an online account for a first user, wherein the user profile comprises a picture of a first user's face; receiving a request from a second user requesting to verify the picture of the first user as being an authentic representation of the first user's face; receiving instructions of a specified pose for the first user to pose in a verification photo; and submitting the verification photo of the first user posing as instructed to the second user for verification.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a flow chart for verifying a user on a social media platform according to one particular embodiment.

FIG. 2 illustrates a flow chart for verifying the identify associated with an online account according to one particular embodiment.

FIG. 3 is a diagram depicting an example computing module used to implement features according to certain embodiments of the provided disclosure.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

In some of the embodiments, disclosed is an account verification system and method for confirming the identity of an account user in real time. The account verification system may be a computer implemented system that includes a mobile processing device or any other electronic processing device with an operating system configured to perform executable instructions and a memory device. Additionally, a mobile or electronic application may be included with instructions executable by the mobile processing device or electronic processing device, where the mobile or electronic application may be configured to create an account verification application for authenticating social media or other online account users in real time for security and verification purposes. The account verification application may include a software module for allowing a user to confirm the identity of another account user via biometric identification using real-time submission of photos. By way of example only, biometric identification may require the authentication of any metrics related to human characteristics. Such human characteristics may include fingerprints, palm veins, facial recognition, retina, body type, body behavior, and the like.

In further embodiments, the software module may be able to access the camera built-in the user's mobile or electronic application. By accessing the camera, this may allow the user to take pictures of himself or herself using the same mobile processing device or other electronic processing device to successfully verify that the user is indeed the same person as reflected in his or her profile picture. In other instances, the camera may take several images so that the software module creates a graphic interchange format (otherwise known as “GIF”). The GIF file may be displayed in succession to create an animated clip or a short movie.

In additional embodiments, the software module may generate random pose or movement instructions requiring the user to take a picture or a succession of pictures of himself or herself performing the requested poses or movements. From herein, a person taking a picture of himself or herself will be referred to as a “selfie.” The selfie may include a picture that features only the person's face, or the selfie may also include a body shot that captures both the body and facial features of the person.

Upon the user taking the verification selfie to validate himself or herself as the person featured in the user's profile picture, the software module of the account verifications system may also include a facial recognition software that verifies and determines whether the person in the verification selfie matches the facial features of the person in the user profile picture in question. Additionally, the software module of the account verification system may also include a gesture recognition software, where the gesture recognition software verifies and determines whether or not the person in the verification selfie has fulfilled the instructional pose as requested. When the respective recognition software successfully verifies one or both of the facial features and requested instructional poses, the user's account may then be considered to be validated.

Additionally, in further embodiments, the verification process may also include another online account user or authorized personnel to validate and authenticate the target user's account. By way of example only, the other online account user or authorized personnel may be the one requesting that the user verify his or her identity, herein referred to as the requestor. Here, the requestor may validate or disapprove the target user's account by determining whether or not the person in the target user's profile picture matches the person in the verification selfie. Additionally, the third person may also validate whether or not the person in the selfie has satisfied the instructional pose as requested. When one or both of the facial features and instruction poses are successfully verified by the requestor, the profile of the user in question may then be confirmed and validated.

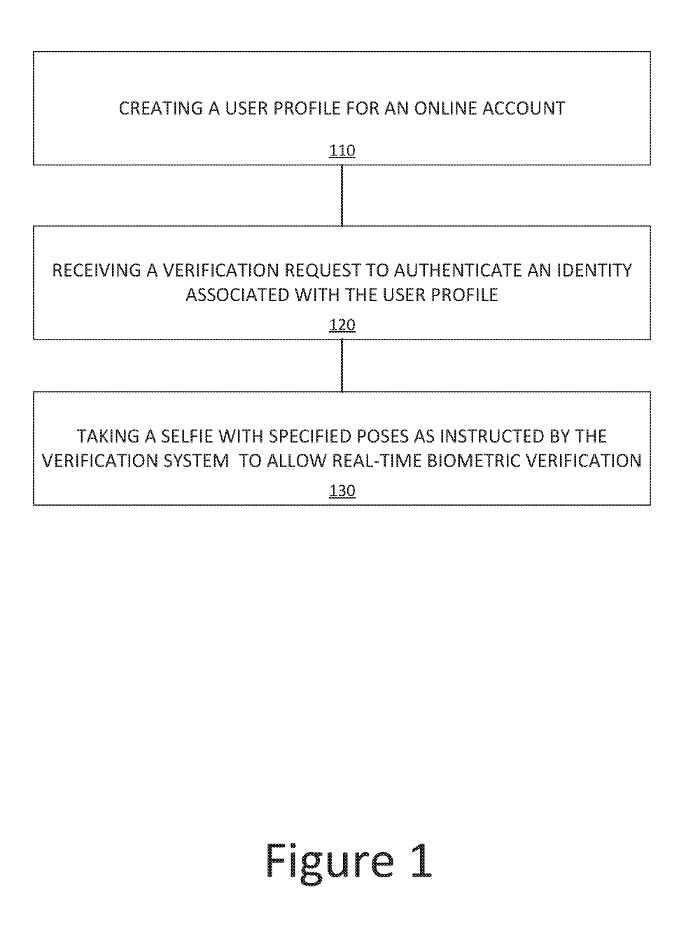

FIG. 1 illustrates a flow chart for verifying a user profile account according to one particular embodiment. By way of example only, the method of verifying a user profile account may first include step 110, which is a user creating an online user profile. The user profile may be associated with any various online accounts, which may include social media accounts, online banking accounts, online gaming accounts, online messaging accounts, online retail accounts and the like. By way of further example only, the user profile may include a visual display of personal data and information associated with the user's identity, such as name, age, birthday, occupation, contact information, educational background, and the like. The personal data may be public information where any user or a specified select group of users may view the information. In other instances, all or certain personal data may be private to the user. Additionally, the user profile page may also require that the user provide a recent or accurate photo of the user to be publicly displayed as the user's profile photo.

Once the user has created a user profile for the online account, the account verification system may be synched with the online account. Because the online account may be accessible via any digital processing device, such as a computer or mobile processing device, the account verification system may be incorporated into a software module that is configured to be executed on the computer or mobile processing device. In some instances, the account verification system may be a software application developed specifically for use on wireless computing devices, such as smartphones and tablets by way of example only.

Next, the method may include step 120, which may include the user receiving a verification request to authenticate his or her identity associated with the online account synced with the verification system. The verification request may be requested by another online user, who may be referred to herein as the requestor. In other words, the requestor may be another user who wishes to verify the online account user in question is indeed the person as portrayed in the user's profile picture. At such an instance, a verification request may pop up on the user's computing device and the user in question may accept or decline the verification request.

If the user in question accepts the verification request, the account verification system may send a notification with a specific set of pose instructions. This ensures that the user in question is verified by biometric identification in real time and that the user cannot merely send an old photo in an attempt to deceive others. As such, the user must then take a photo of himself or herself successfully executing these instructed poses and submit them. The account verification system may access the camera already integrated on the mobile or electronic computing device. By accessing the camera, the user may be able to take a selfie through the verification system.

By way of example only, the specific pose instructions may require that the user take a selfie with a specified hand motion, facial expression, body motion or combinations thereof. Such pose instructions may include saluting, waving, making a peace sign, mimicking round eyeglasses by placing rounded hands over each eyes, sticking out the tongue, making a wide rounded “o” shape with the mouth or other shapes, twirling, performing jumping jacks, and the like. The pose instructions may can include any wide range of poses and gestures that that can be recognized by various facial and gesture recognition software installed in the account verification system.

By way of example only, the account verification system may require that the user take the verification selfie within a set time frame of accepting the verification request and the set of pose instructions. By doing so, this may allow real-time verification of the user's online account. Once the user has taken the selfie with the instructed pose, the account verification system may validate the identity of the account user. In some embodiments, the account verification system may validate only the user's facial feature while in other embodiments, the account verification system may validate only the satisfaction of the pose requirements. In other instances, the account verification system may require that the system confirms both the user's facial features and instructional poses before validating the user's account.

Next, by way of example only, the verification selfie may then be delivered to the requestor. There, the requestor will be able to view the specific pose instructions given to the user in question and be able to determine whether or not the user in question has successfully executed the poses as instructed. Additionally, the requestor may also be able to personally determine whether or not the person in the verification selfie matches the person in the user's profile picture. If both the poses and the facial features are deemed to be satisfied by the requestor, then the requestor may confirm and verify the identity of the user in question.

However, if the requestor determines that the facial or physical features of the person in the verification selfie are not identical or similar enough to the person as represented in the user's profile picture, the requestor may determine and conclude that the user's profile is unverified. Upon doing so, the requestor may make the active decision as to whether or not to communicate with the user in question.

In some instances, the user in question may be notified whether the requestor has validated or rejected the user's profile. In other instances, the requestor's selected determination of validating or rejecting the user's profile may be kept private from the user in question. Additionally, by way of example only, the verification selfie may be automatically erased from the account verification system after a select time frame. By way of further example only, the verification selfie may be erased after 5 minutes of being sent to the requestor for review. However, it should be noted that the time frame may be of any varying length as appreciated by one of ordinary skill in the art.

Additionally, the online account may incorporate a profile rating based on the number of validations or invalidations a user receives from the recognition software (facial and/or gesture recognition software) of the account verification system. In other instances, the profile rating may be dependent on the number of validations or invalidations a user receives from the requestors. In other examples, the profile rating may be based on both the number of validations or invalidations a user receives from the recognition software (facial and/or gesture) and the requestors. As such, a low profile rating may indicate that the recognition software and/or requestors have determined that the user's profile photo inaccurately reflects his or her verification selfies. The low profile rating may also be due to the user failing to successfully perform the instruction poses as requested by the account verification system. On the other hand, a high profile rating may indicate that the recognition software and/or requestors have determined that the user's profile photo accurately reflects his or her verification selfies. Additionally, the high profile rating may also be due in part or whole to the user successfully posing the requested instructional poses in his or her submitted verification selfies. Thus, if a user has a low profile rating, this may indicate to the user that a new or updated profile picture should be taken to more accurately depict his or her current physical appearance.

On one hand, by way of example only, the user's profile rating may be private that is only shared between the account verification system and the user. In other instances, the user's profile rating may by public information that is displayed on the user's profile page. By doing so, this may provide a quick and preliminary determination to any other user as to whether or not he or she wishes to proceed and maintain communications with the user in question.

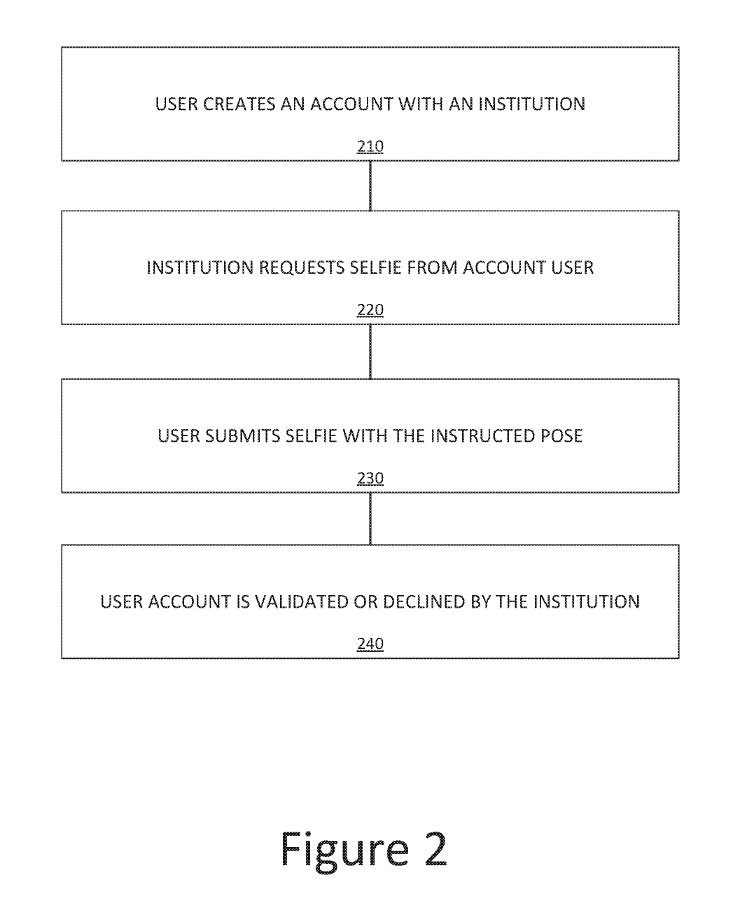

FIG. 2 illustrates a flow chart for verifying the identify associated with the account according to one particular embodiment. Here, in this embodiment, the user may be seeking the validation of his or her identity to obtain access to his or her online user account, where the user account is associated with an institution or company. By way of example only, the institution or company may include banks, schools, retailers, and the like. Because many of these institution or companies have an online presence where they offer their goods and/or services online, a user may be required to create an online account before being granted access to their goods and/or services.

Often, these online accounts store and gather the user's private information, such as credit card information, date of birth, answers to security questions, social security number, and the like. As such, these online accounts often require the account user to verify his or her identity via passcodes or passwords. However, passcodes and passwords are often forgotten, especially if a user has multiple online accounts to manage. As a result, utilizing the account verification system with real time biometric identification may allow for a secure method of verifying a user without the need for passwords or inputting other sensitive personal information.

As such, the method may include step 210, where the user creates an online user account with the institution. By way of example only, this step may include requiring the user select a photo of himself or herself to be used as his or her profile picture. In some instances, the profile picture may consist of multiple head shots of the user and at various head angles and positions. By providing multiple head shots, this allows the account verification system and anyone comparing the user's profile picture with his or her verification selfie to make a more accurate determination as to the identity of the user.

Next, the method may include step 220, where the institution may request a verification selfie from the account user. This request may be initiated when the user wishes to access his or her online account. This may occur in instances where the online account is secured and needs to be verified by the institution before the account user is granted access to the online account at issue. When the institution requests the verification selfie from the account user, a request notice to verify the user's identity may pop up on the screen of the user interface, such as the user's electronic device. Here, the user may have the option of approving and declining the verification request. When the user approves the verification request, a set of pose instructions may also pop up on the screen of the user interface, where the pose instructions include random hand and/or body gestures generated by the verification system. When the pose instructions are delivered to the user, the user may be required to submit a verification selfie of himself or herself performing the requested pose instructions within a set time period. If the user fails to submit the selfie or video within the set time period, the user may have to request a new set of pose instructions. This time period limitation may ensure that the biometric verification is performed in real time.

When the user takes the verification selfie with the instructed pose, the user may submit the selfie to the institution via the account verification system at step 230. At this verification step, the facial recognition software integrated into the account verification system may compare the facial features of the verification selfie to the user's account profile picture. At step 240, the user account may then be validated or declined by the institution based upon the review of the verification selfie. This verification step may also include a motion or gesture recognition software that detects and confirms whether or not the user in the selfie is performing the motion or gesture as required in the pose instructions. If the account verification system determines that the user did not satisfy the facial or pose instructions based on the determination of the facial and motion or gesture recognition software, the account verification system may send the user an alert and notification to take another verification selfie. By way of example only, the account verification system may allow the user certain number of attempts before locking the account and preventing the user from accessing the account.

In some embodiments, the user's verification selfie may be validated by an authorized personnel associated with the institution. This personnel may receive the verification selfie and make the judgement as to whether the facial features and/or requested poses have been satisfied.

In some embodiments, the verification selfie may have to be approved by the facial and motion recognition software and an authorized personnel associated with the institution. In other instances, the verification selfie may only need to be approved by the facial and motion recognition software. However, when one or too many attempts have failed, the verification selfie may be sent to the personnel associated with the institution for back-up verification.

However, if the verification selfie is approved, the user may be notified and the user may then successfully gain access to his or her account. Furthermore, by way of example only, the verification selfies taken may be deleted after the verification selfie has been sent and viewed by the verification system or the personnel associated with the institution. By way of further example only, the verification selfie may be deleted after a certain time frame after the verification selfie has been sent to the facial/motion recognition software and/or authorized personnel.

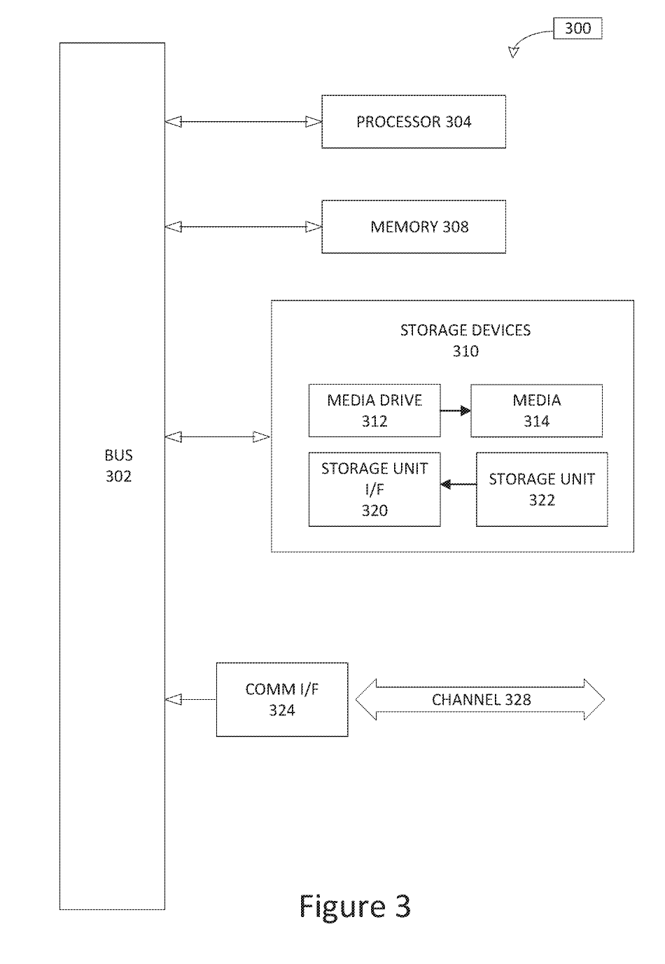

As used herein, the term module may describe a given unit of functionality that may be performed in accordance with one or more embodiments of the present application. As used herein, a module may be implemented utilizing any form of hardware, software, or a combination thereof. For example, one or more processors, controllers, ASICs, PLAs, PALs, CPLDs, FPGAs, logical components, software routines or other mechanisms may be implemented to make up a module. In implementation, the various modules described herein may be implemented as discrete modules or the functions and features described may be shared in part or in total among one or more modules. In other words, as would be apparent to one of ordinary skill in the art after reading this description, the various features and functionality described herein may be implemented in any given application and may be implemented in one or more separate or shared modules in various combinations and permutations. Even though various features or elements of functionality may be individually described or claimed as separate modules, one of ordinary skill in the art will understand that these features and functionality may be shared among one or more common software and hardware elements, and such description shall not require or imply that separate hardware or software components are used to implement such features or functionality.

Where components or modules of the application are implemented in whole or in part using software, in one embodiment, these software elements may be implemented to operate with a computing or processing module capable of carrying out the functionality described with respect thereto. One such example computing module is shown in FIG. 3. Various embodiments are described in terms of example computing module 300. After reading this description, it will become apparent to a person skilled in the relevant art how to implement the application using other computing modules or architectures.

Referring to FIG. 3, computing module 300 may represent, for example, computing or processing capabilities found within mainframes, supercomputers, workstations or servers; desktop, laptop, notebook, or tablet computers; hand-held computing devices (tablets, PDA's, smartphones, cell phones, palmtops, etc.); or the like, depending on the application and/or environment for which computing module 500 is specifically purposed.

Computing module 300 may include, for example, one or more processors, controllers, control modules, or other processing devices, such as a processor 304. Processor 304 may be implemented using a special-purpose processing engine such as, for example, a microprocessor, controller, or other control logic. In the illustrated example, processor 304 is connected to bus 302, although any communication medium may be used to facilitate interaction with other components of computing module 300 or to communicate externally.

Computing module 300 may also include one or more memory modules, simply referred to herein as main memory 308. For example, random access memory (RAM) or other dynamic memory may be used for storing information and instructions to be executed by processor 304. Main memory 308 may also be used for storing temporary variables or other intermediate information during execution of instructions to be executed by processor 304. Computing module 300 may likewise include a read only memory (ROM) or other static storage device coupled to bus 302 for storing static information and instructions for processor 304.

Computing module 300 may also include one or more various forms of information storage devices 310, which may include, for example, media drive 312 and storage unit interface 320. Media drive 312 may include a drive or other mechanism to support fixed or removable storage media 314. For example, a hard disk drive, a floppy disk drive, a magnetic tape drive, an optical disk drive, a CD or DVD drive (R or RW), or other removable or fixed media drive may be provided. Accordingly, removable storage media 314 may include, for example, a hard disk, a floppy disk, magnetic tape, cartridge, optical disk, a CD or DVD, or other fixed or removable medium that is read by, written to or accessed by media drive 312. As these examples illustrate, removable storage media 314 may include a computer usable storage medium having stored therein computer software or data.

In alternative embodiments, information storage devices 310 may include other similar instrumentalities for allowing computer programs or other instructions or data to be loaded into computing module 300. Such instrumentalities may include, for example, fixed or removable storage unit 322 and storage unit interface 320. Examples of such removable storage units 322 and storage unit interfaces 320 may include a program cartridge and cartridge interface, a removable memory (for example, a flash memory or other removable memory module) and memory slot, a PCMCIA slot and card, and other fixed or removable storage units 322 and storage unit interfaces 320 that allow software and data to be transferred from removable storage unit 322 to computing module 300.

Computing module 300 may also include a communications interface 324. Communications interface 324 may be used to allow software and data to be transferred between computing module 300 and external devices. Examples of communications interface 324 include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 324 may typically be carried on signals, which may be electronic, electromagnetic (which includes optical) or other signals capable of being exchanged by a given communications interface 324. These signals may be provided to communications interface 324 via channel 328. Channel 328 may carry signals and may be implemented using a wired or wireless communication medium. Some non-limiting examples of channel 328 include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, main memory 308, storage unit interface 320, removable storage media 314, and channel 328. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions may enable the computing module 500 or a processor to perform features or functions of the present application as discussed herein.

Various embodiments have been described with reference to specific example features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various example embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the present application, whether or not such embodiments are described and whether or not such features are presented as being a part of a described embodiment. Thus, the breadth and scope of the present application should not be limited by any of the above-described example embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide illustrative instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed in multiple groupings or packages or across multiple locations.

Additionally, the various embodiments set forth herein are described in terms of example block diagrams, flow charts, and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for biometric identification comprising:
a processor;
a memory attached to the processor; and
a computer readable medium having instruction embedded therein, the instructions configured to cause the processor to perform the operations of:
creating a user profile for an online account for a first user, wherein the user profile comprises a picture of a first user's face;
receiving a request from a second user requesting to verify the picture of the first user as being an authentic representation of the first user's face;
presenting through a computing device instructions of a specified pose for the first user to pose in a verification photo; and
submitting the verification photo of the first user with the specified pose to the second user for verification.

2. The system of claim 1, wherein the verification photo comprises a head shot of the first user.

3. The system of claim 1, wherein the verification photo comprises a body shot of the first user.

4. The system of claim 1, wherein the verification photo is in a graphic interchange format file.

5. The system of claim 1, wherein the specified pose comprises at least one of a hand gesture, facial expression, and body motion.

6. The system of claim 1, further comprising comparing the facial features of the first user's profile picture to a person in the verification photo.

7. The system of claim 1, further comprising verifying the pose of the verification photo as satisfying the pose instructions.

8. The system of claim 6, wherein the facial features are first user's profile picture is compared and analyzed to the verification photo using a facial recognition software.

9. The system of claim 7, wherein the pose of the verification photo is compared and analyzed to the pose instructions using a gesture recognition software.

10. The system of claim 1, wherein the second user determines whether the first user in the verification photo matches a person as indicated in the picture of the user's profile.

11. The system of claim 10, wherein the second user verifies the first user's profile when the verification photo satisfies the specified pose as instructed.

12. The system of claim 11, wherein the second user verifies the first user's profile when the verification photo accurately represents a person as presented in the picture of the user's profile.

13. The system of claim 1, further comprising generating a profile rating score, wherein a higher profile rating score is generated when the second user verifies the first user's profile.

14. The system of claim 1, wherein the second user is associated with an institution comprising at least one of banks, schools, social media companies, and retailers.

15. The system of claim 14, wherein the institution allows the first user access to the online account only after the verification photo is validated by the institution.

16. A method for real-time biometric identification comprising:
creating a user profile for an online account for a first user, wherein the user profile comprises a picture of a first user's face;
receiving a request from a second user requesting to verify the picture of the first user as being an authentic representation of the first user's face;
receiving instructions of a specified pose for the first user to pose in a verification photo; and
submitting the verification photo of the first user posing as instructed to the second user for verification.

17. The method of claim 16, wherein submitting the verification photo must be performed within a set time frame to ensure real-time verification of the first user.

18. The method of claim 16, wherein the second user validates the first user's profile when the verification photo satisfies the specified pose as instructed and also verifies that a person in the verification photo is the same person as presented in the picture of the user's profile.

19. The method of claim 16, further comprising generating a profile rating score, wherein a higher profile rating score is generated when other users validates the first user's profile.

20. The method of claim 16, wherein the second user is associated with an institution and the first user is only granted access to the online account after the institution validates the verification photo.
